(19) United States
(12) Patent Application Publication
(10) Pub. No.: US 2009/0173696 A1
(43) Pub. Date: Jul. 9, 2009

(54) METHOD AND SYSTEM OF DIGESTING EXCESS SLUDGE

(75) Inventors: Tugio Tachikawa, Hyogo (JP); Hiroshi Tachikawa, Hyogo (JP); Hideo Tachikawa, Hyogo (JP)

Correspondence Address: SUGHRUE MION, PLLC, 2100 PENNSYLVANIA AVENUE, N.W., SUITE 800, WASHINGTON, DC, 20037, US

(73) Assignee: ES. Technologies Corp., Himeji-shi, Hyogo (JP)

(21) Appl. No.: 12/294,312

(22) PCT Filed: Mar. 26, 2007
(86) PCT No.: PCT/JP2007/057602

§ 371 Date: Sep. 24, 2008

(30) Foreign Application Priority Data
Mar. 27, 2006 (JP) 2006-086178
May 11, 2006 (JP) 2006-132598

(51) Int. Cl. C02F 11/14; C02F 1/76; B01D 21/02; B01D 21/34; C02F 103/00

(52) U.S. Cl. 210/744; 210/754; 210/756; 210/207; 210/86

(57) ABSTRACT

In an activated sludge treatment of organic waste water, excess sludge from the activated sludge aeration vessel is processed with hypochlorous acid in place of ozone without set up of aeration vessels and blowers to improve volume reduction cost of sludge without deterioration of water quality. The hypochlorous acid process is carried out by using an acidulous sodium hypochlorite aqueous solution which is prepared by mixing sodium hypochlorite aqueous solution with a dilute hydrochloric acid and diluting the resulting mixture with water within 1,000 ppm to 50,000 ppm of available chlorine concentration at a pH zone of more than 4 to less than 7.

### BACKGROUND OF THE INVENTION

This invention is related to a method of digesting excess sludge produced in an activated sludge process, especially to a continuous treating system of excess sludge produced in an activated sludge unit for treating an organic waste water.

When the organic waste water is processed in the activated sludge process unit, from an aeration vessel of the activated sludge process, there is produced a large quantity of excess sludge. The produced excess sludge is usually discharged or is incinerated after dehydration. Due to shortage of incineration facility, high cost problem of treatment and so on, a new sludge reduction technology has been sought.

Recently, many system of excess sludge reduction has been proposed wherein excess sludge can be modified and decomposed by a variety of methods and means to make excess sludge partially into liquefication (modification or resolution) and the modified sludge is returned to the aeration vessel in the activated sludge unit to reduce the volume of excess sludge, most desirably to make excess sludge zero depending on the condition.

Among them, the sludge reduction in Japanese patent publication (Kokai) 2002-224699, is most promising wherein excess sludge treated by ozone and digested in the aeration vessel.

However, this excess sludge volume reduction system has not been developed and practiced sufficiently by the following reasons although the effect of sludge reduction can be validated.

That is, even in the above ozone treatment reduction the aerobic digestion of the sludge is carried out in the aeration vessel of activated sludge treatment wherein waste water is being treated and the excess sludge is being produced. Therefore, pollutant load in this aeration vessel becomes 1.3 to 1.5 times of that in case of no aerobic digestion, resulting in shortage of treatment capacity of aeration vessel due to addition of excess sludge. Further, much more volume of air is needed for aerobic digestion so that oxygen is required more than 1.3 times of that in case of no aerobic digestion. Further more blowers can be required to supply ozone for the aerobic digestion.

The main reason of difficulty in practicing excess sludge reduction by aerobic digestion is in the need for much more capacity of aeration vessels and many blowers in contrary to excellent result of excess sludge reduction system due to aerobic digestion.

Furthermore, supply of ozone needs an expensive ozone generator so that there is a problem that facility cost is much increased by using such an expensive ozone generator.

### SUMMARY OF THE INVENTION

A main object of the present invention is to solve the conventional problem and to provide a method or system of effective digesting excess sludge produced by treatment of organic waste water in an activated sludge process without extension of aeration vessels and blowers and use of ozone.

A second object of the present invention is to provide a method or system of realizing a large volume reduction of excess sludge.

According to a first aspect of the present invention, it is to provide a method of digesting excess sludge produced in activated sludge system which comprises;

taking the excess sludge from an activated sludge unit or a sludge sedimentation vessel and dumping the excess sludge into a sludge digesting unit

processing at least a part of the excess sludge in the sludge digesting unit by mixing the sludge with an acidulous hypochlorous acid solution at a mixture ratio of 500˜5,000 ppm based on excess sludge of about 10,000 mg/L after mixing,

returning to the activated sludge unit or discharging the sludge to be processed

up to a degree of substantially inert residual chlorine concentration.

According to a second aspect of the present invention, it is to provide an equipment of digesting excess sludge produced in activated sludge system which comprises; an activated sludge unit and a sludge sedimentation vessel,

a sludge digesting unit for processing at least a part of the excess sludge provided with means of mixing

a means for preparing an acidulous sodium hypochlorite aqueous solution of 1,000˜50,000 ppm which is acidificated to pH of more than 4 to less than 7 by a hydrochloric acid depending on the property of sludge,

a means for supplying the acidulous sodium hypochlorite aqueous solution to the excess sludge in the sludge digesting unit at a mixture ratio of 50-2,000 ppm depending on the sludge concentration in the sludge digesting unit,

a first path for supplying excess sludge taken from an activated sludge unit or a sludge sedimentation vessel,

a second path for returning the sludge water to be processed to the activated sludge unit,

a means for measuring residual chlorine concentration in the processed sludge,

a means for making the processed sludge substantially inert in the residual chlorine concentration.

In the preferred embodiment, the sludge digesting unit may comprises a plurality of mixing vessels 31 to 33 communicated in turn, each of which is provided with a supplier for the acidulous sodium hypochlorite aqueous solution in a manner that the concentration of acidulous sodium hypochlorite aqueous solution is decreased from the upper-stream vessel to the lower-stream vessel. Further, in order to make the sludge water substantially inert a residual chlorine processing unit may be provided in a return path from the sludge digesting unit to the activated sludge unit, wherein depending on a residual chlorine concentration in the processed sludge, a determined amount of the excess sludge is charged into the processed sludge. In place of the above or in addition to the above, an auxiliary storage vessel may be provided at a return side of the activated sludge unit, wherein some excess sludge is stocked to make the hypochlorous acid processed sludge substantially inert. Furthermore, in response to residual chlorine concentration measured by the measuring unit, there may be provided a control unit for adjusting a mixture ratio of the hypochlorous acid to the sludge water in the sludge digesting unit, a charge amount of the sludge water to the residual chlorine processing unit, and/or a sludge concentration in the auxiliary storage vessel.

In the activated sludge process, it is well known to the skill in the art that ozone oxidation used for excess sludge treatment is not harmful when the processed sludge is return to the activated sludge because ozone is decomposed to oxygen which is not harmful to microorganism used for the activated sludge process. However, it is surprising that hypochlorous acid treatment used for sterilizing microorganism is useful for sludge volume reduction without no problem in the activated sludge process if the residual chlorine concentration should be substantially inert.

According to the present invention, 1) it is not necessary to use an expensive ozone generator, so that sludge volume reduction can be done at a lower cost.

Further, 2) a large volume reduction of excess sludge can be done by means of simple facility and it is possible that continuous treatment of excess sludge can make excess sludge become zero.

Furthermore, 3) acidulous hypochlorous acid will be decomposed and dissipated by digesting sludge, so that the processed sludge can be returned to be resusable in activated sludge system.

Furthermore, 4) the excess sludge can be deodorized completely without deterioration of water quality.

### BRIEF DESCRIPTION OF THE DRAWINGS

FIG. 1 is a schematic diagram showing a first total system for excess sludge reduction process.

FIG. 2 is a schematic diagram showing a combination of a hypochlorous acid preparation apparatus and a sludge digesting unit.

FIG. 3 is a schematic diagram showing a second total system for excess sludge reduction process.

FIG. 4 is a diagram showing mechanism of digesting the excess sludge.

### DETAILED DESCRIPTION OF THE PREFERRED EMBODIMENT

According to the present invention, the method of digesting excess sludge produced in activated sludge system with hypochlorous acid which comprises;

1) taking the excess sludge from an activated sludge unit or a sludge sedimentation vessel and dumping the excess sludge into a sludge digesting unit

2) hypochlorous acid processing at least a part of the excess sludge in the sludge digesting unit by mixing the sludge with an acidulous hypochlorous acid aqueous solution at a mixture ratio of 500˜5,000 ppm based on excess sludge of about 5,000 to 10,000 mg/L after mixing,

3) returning to the activated sludge unit or discharging out the processed sludge with a degree of substantially inert residual chlorine concentration.

In a preferred embodiment, the hypochlorous acid process may be carried out by use of an acidulous sodium hypochlorite aqueous solution of 1,000˜50,000 ppm which is acidificated to pH of more than 4 to less than 7 by sodium hypochlorite aqueous solution, because the electrolysis method can not make a high concentration of hypochlorite aqueous solution of 1,000˜50,000 ppm and acidulous sodium hypochlorite aqueous solution is more effective in digesting process than sodium hypochlorite aqueous solution without sodium hypochlorite aqueous solution.

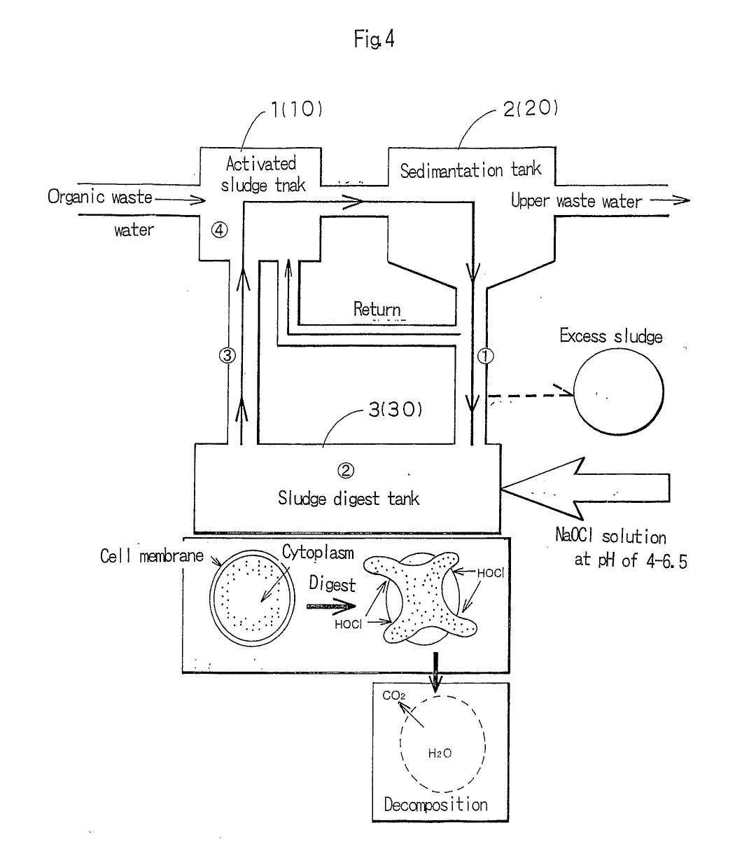

In a further preferred embodiment, the hypochlorous acid process is carried out by a plurality of digesting vessels connected with each other so as to make the excess sludge flow therethrough, wherein available chlorine concentration of the acidulous sodium hypochlorite aqueous solution to be mixed with the excess sludge flow in the upper-stream vessel is higher than that of the lower-stream vessel, because the digesting process shown in FIG. 4 can proceeds more easily and effectively.

In a furthermore preferred embodiment, a return path from the sludge digesting unit to the activated sludge unit, is provided with a residual chlorine processing unit, wherein a residual chlorine concentration in the processed sludge is measured, and depending on the measured signal, a determined amount of the excess sludge is charged into the processed sludge in order to make the residual chlorine concentration substantially inert state, because the acidulous sodium hypochlorite aqueous solution is a sterilizer for microorganism in the activated sludge vessel. In place of the above, at a return side of the activated sludge unit there may be provided an auxiliary storage vessel, wherein some excess sludge is stocked to be mixed with the return processed sludge water and to make the processed sludge water substantially inert in the residual chlorine concentration. Therefore, in order to measure the residual chlorine concentration in the processed sludge there may be provided a measuring unit at the return path from the sludge digesting unit to the activated sludge and in response to the residual chlorine concentration measured by the measuring unit, a mixture ratio of the acidulous sodium hypochlorite aqueous solution to the sludge water in the sludge digesting unit, a charge amount of the sludge water to the residual chlorine processing unit, and/or a sludge concentration in the auxiliary storage vessel can be adjusted in order to make the residual chlorine concentration substantially inert state.

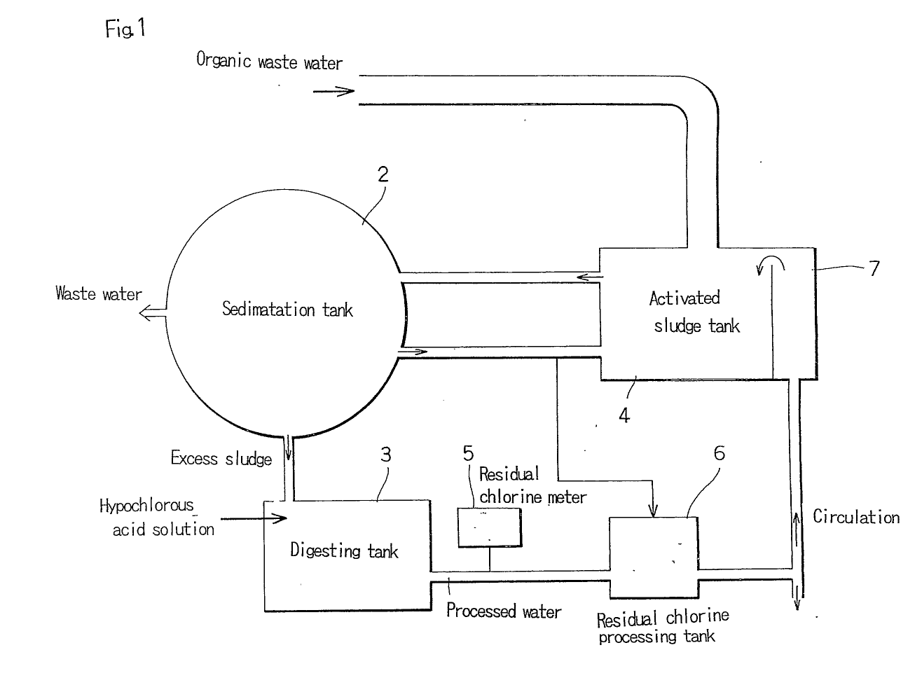

In FIG. 1, there is shown a typical circulation system for carrying out the above preferred process of digesting excess sludge produced in activated sludge process, which comprises an activated sludge unit 1, a sludge sedimentation vessel 2 and a sludge digesting unit 3. In the sludge digesting unit 3, the excess sludge taken out from sludge sedimentation vessel 2 is digested to a dissolution state and the treated sludge is returned to the activated sludge unit 1.

In this activated sludge treatment facility, the organic waste water is firstly subjected to an activated treatment in the activated sludge vessel 1 and then subjected to solid-liquid separation in the sedimentation vessel 2 wherein separated water is discharged out of system while separated sludge is prepared to adjust sludge concentration suitable to the activated sludge treatment such as 2,000˜10,000 mg, preferably 2,000 to 5,000 mg/L by circulating a part of digested excess sludge to the activated sludge vessel 1 and discharging the remainder out of system.

In the facility of excess sludge treatment shown in FIG. 1, the excess sludge drawn from the sedimentation vessel 2 is transferred as a water of excess sludge having a concentration of 5,000 to 10,000 ppm to a sludge digesting unit 3, wherein a hypochlorous acid preparation device 4 provides an acidulous sodium hypochlorite aqueous solution (3,000˜15,000 ppm) to digest the sludge water by hypochlorous acid treatment. The resulting processed sludge is circulated back to the activated sludge vessel 1 with making residual chlorine concentration of the processed sludge to substantially inert state. Therefore, a potential of the processed sludge should be measured by a residual chlorine measuring device 5 such as oxidation-reduction potential meter and so on. Then, according to the measured potential an additional excess sludge water is added to a residual chlorine processing unit 6 positioned in a return path from the sludge digesting unit 3 to the activated sludge unit 1, wherein depending on a residual chlorine concentration in the processed sludge, a determined amount of the excess sludge is charged into the processed sludge in residual chlorine processing unit 6 to make the residual chlorine concentration substantially into an inert state. In making the sludge water substantially inert an auxiliary storage vessel 7 may be provided at a return side of the activated sludge unit 1, wherein some excess sludge is stocked to make the hypochlorous acid processed sludge substantially inert concerning the residual chlorine concentration.

As shown in FIG. 1, the inventive facility additionally comprises the following units and vessels which function will be explained.

Sludge Digesting Unit 3

In the sludge digesting unit 3, the excess sludge can be digested to get volume reduction, wherein hypochlorous acid treats the sludge and dissolve the sludge composed of stable Glycolipid and Lipoprotein (organism producing polymer) to get decomposition as shown in FIG. 4.

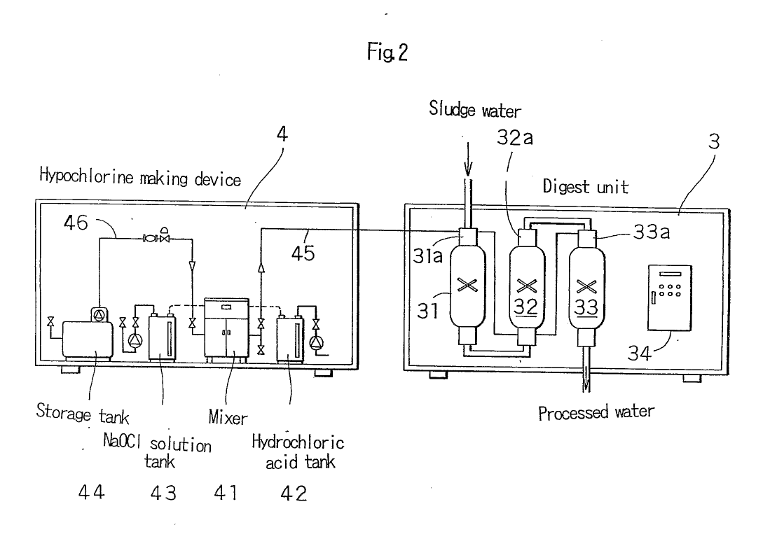

The hypochlorous acid treatment is carried out in the sludge digesting unit 6 wherein an acidulous sodium hypochlorite aqueous solution is added to the sludge solution under mixing and is being kept at an acidulous condition having a pH of more than 4 and less than 7 in order to improve the hypochlorous acid treatment. The amount of hypochlorous acid solution to be charged in the sludge digesting unit 6 should be determined to be within 500 to 5,000 ppm of hypochlorous acid or available chlorine concentration after mixing with the sludge based on excess sludge of about 5,000 to 10,000 mg/L. In the sludge digesting unit 6, the amount of hypochlorous acid can be adjusted and modified while treating. For example, as shown in FIG. 2 the digesting unit 3 preferably comprises a plurality of oblong mixing vessels 31, 32 and 33 communicated in series, each of which is provided at each charging ports 31a, 32a and 33a with a supplier for the acidulous sodium hypochlorite aqueous solution from a hypochlorine making device 4, wherein the acidulous sodium hypochlorite aqueous solution is prepared by mixing sodium hypochlorite from NaOCl solution tank 43 and an inorganic acid such as hydrochloric acid from Hydrochloric acid tank 42 in a mixer 41 and diluting the resulting solution with water so as to get a concentration of 1,000˜50,000 ppm, preferably 3,000˜15,000 ppm at a pH of more than 4 to less than 7. The concentration to be added in each of the mixing vessels 31 to 33 can be controlled by a signal measured by a residual chlorine meter 34 in a manner that the available chlorine concentration (as a concentration of hypochlorous acid or ion) of the upper-stream vessel 31 is higher than that of the lower-stream vessel 32 or 33.

Hypochlorine Making Device 4

The hypochlorous acid aqueous solution can be easily prepared on-site by a mixer 41 of “STERI mixer” made in HSP Co. Ltd in Japan. The hypochlorous acid aqueous solution made on site is at a pH of 4 to 6.5 and at a concentration of 3,000 to 15,000 ppm, so that the hypochlorous acid aqueous solution can be used in a diluted form or not diluted form. As shown in FIG. 2, the hypochlorine making device comprises mixer 41, a first supplier 42 for supplying a diluted hydrochloric acid to the mixer 41 and a second supplier 43 for supplying acidulous sodium hypochlorite aqueous solution to the mixer 41, wherein acidulous sodium hypochlorite aqueous solution of 1,000 to 50,000 ppm, preferably 3,000 to 15,000 ppm can be prepared. The concentration of the aqueous solution is generally decided according to the concentration of sludge to be processed and the property of sludge to be processed. And then some of the hypochlorous acid aqueous solution having a determined concentration is supplied through a supplying line 45 to the sludge digesting unit 3 and the remaining solution is kept in a storage tank 44 through a line 46.

When the acidulous sodium hypochlorite aqueous solution is prepared, a dilute hydrochloric acid of less than 30%, preferably less than 15%, more preferably less than 12% may be preferably used in mixing with aqueous solution of sodium hypochlorite within a pH zone of more than 4 to less than 6.5, preferably more than 4.5 to less than 6 and is diluted with water up to 3,000 ppm to 15,000 ppm of available chlorine concentration because the sodium hypochlorite solution generates chlorine gas at less than pH 4. To avoid lowering pH below 4, it is recommendable to use a pH buffering agent such as Acetic acid-sodium acetate aqueous solution, Tartaric acid solution aqueous solution, and Phthalic acid hydrogen potassium-Sodium hydroxide aqueous solution. Additionally, sodium or potassium hydrogen carbonate can be used.

The activated sludge vessel 1 is used to decompose and digest a modified excess sludge by microorganism. If the concentration of the excess sludge would be at 20,000 mg/L, the activated sludge treatment generally produces the excess sludge of about 10,000 mg/L as converted score of TOC and about 27000 mg/L as a converted score of COD. Further, in order to improve effectiveness of hypochlorous acid treatment, it is preferable to keep the value of pH in the sludge digesting unit 3 more than 4, so that a useful kind of microoganizm to be active in the activated sludge vessel should be selected.

As well, the digest treatment sludge liquid is generally at a temperature of 25 to 40° C. When the processed sludge is subjected to membrane separation, the processed sludge had better be cooled by a cooling means.

According to the inventive method of excess sludge treatment, the excess sludge can be digested by the hypochlorous acid treatment so as to make volume reduction to zero. In some cases, the excess sludge contains inorganic material and organic substance difficult to be decomposed. Therefore, it is not necessary to make the volume reduction rate zero.

The facility of excess sludge treatment as shown in FIG. 1 is one typical embodiment according to the invention, so the skill in the art can modify the embodiment in the scope of the invention as follows.

In a return path from the sludge digesting unit 3 to the activated sludge vessel 1, there may be provided with a residual chlorine processing unit 6 wherein depending on residual chlorine concentration of the processed sludge, additional excess sludge can be added from the activated sludge vessel 1 so as to make a residual chlorine concentration of the processed sludge substantially inert.

Further, at a return side of the activated sludge vessel 1, there can be provided with an auxiliary storage vessel 7 wherein the auxiliary storage vessel stores some excess sludge which is used to process sludge and make a residual chlorine concentration of the returned processed sludge substantially inert.

Further, there may be provided with a residual chlorine meter 5 at a return path from the sludge digesting unit to the activated sludge vessel 1, wherein depending on residual chlorine concentration of the processed sludge to be measured by the residual chlorine meter 5 a mixing ratio of hypochlorous acid to sludge in the sludge digesting unit 3, an amount of sludge charged in the residual chlorine processing unit 6 and a concentration of sludge in the auxiliary storage vessel 7 can be adjusted or controlled.

As discussed above, according to the excess sludge circulating type treatment system, the excess sludge produced from the organic waste water in the activated sludge treatment can be effectively treated by means of hypochlorous acid treatment without extension or addition of aeration vessels and blowers and resulting in much volume reduction in circulation treatment.

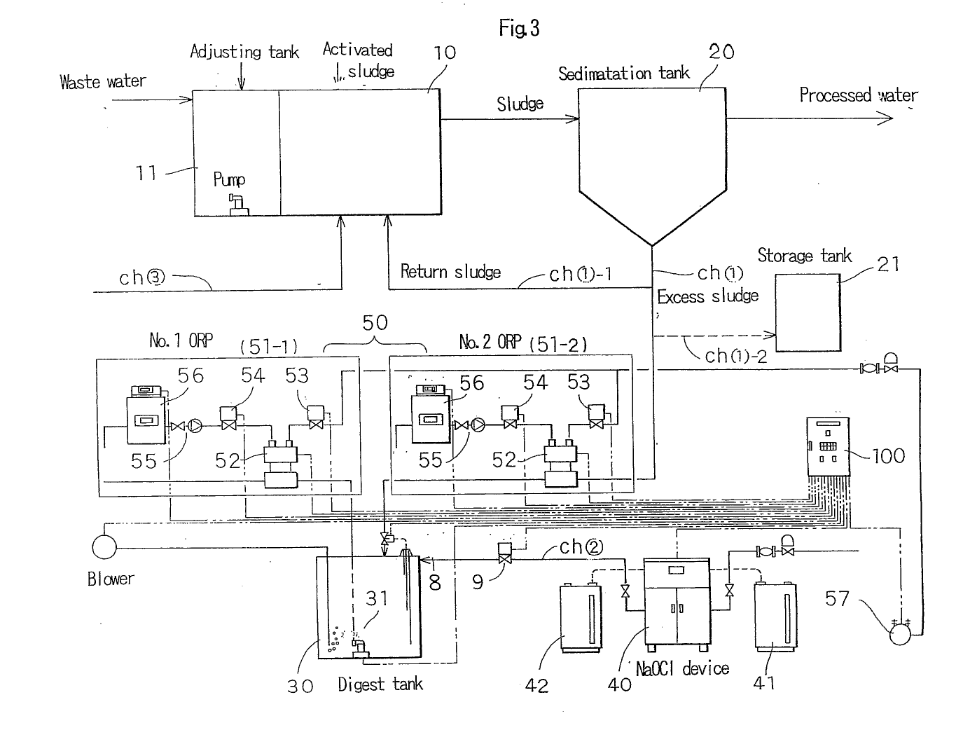

FIG. 3 shows a second example for circulation system according to the present invention wherein an activated tank 10 for processing an organic waste water by organism, a sedimentation tank 20, a digest tank 30 for digesting excess sludge are connected with a first supplying path Ch(1) and a second supplying path Ch(3). The digest tank 30 is connected through a path Ch(2) with NaOCl solution making Device 40 wherein acidulous sodium hypochlorite aqueous solution of 1,000˜50,000 ppm is prepared by mixing sodium hypochlorite from a tank 41 with water and acidificating it to pH of more than 4 to less than 7 by hydrochloric acid from a tank 42. The acidulous sodium hypochlorite aqueous solution is supplied through the path Ch(2) to the digest tank depending on an amount of excess sludge measured by a level sensor 8 under controlled by a control valve 9 so as to adjust the mixing ratio of acidulous sodium hypochlorite aqueous solution with the sludge to 500 to 5,000 ppm, preferably 1,000 to 3,000 ppm based on excess sludge of about 5,000 to 10,000 mg/L. The control valve is controlled through a controller 100 by a signal which is measured by a measuring device for detecting a residual chlorine concentration.

In detail, the activated sludge tank 10 is provided with a flow adjusting tank 11 with a water pump and the sedimentation tank 20 comprises a first supplying path Ch(1), which is branched into 3 ways, a first one being returned to the activated tank 10, a second one being connected to a sludge storage tank 21 and a third one being connected to the digest tank 30. In the digest tank, the charge amount of the sludge is measured by means of the level sensor 8. On the other side, the digest tank 30 is connected with a hypochlorite solution supplying device through the control valve 9 provided at the return path Ch(3) so as to control the charge amount of the sludge and adjust the mixing ratio of acidulous sodium hypochlorite aqueous solution with the sludge water (per kg of 5,000 to 10,000 ppm sludge water) to 500 to 5,000 ppm. The mixing ratio is determined depending on the signal measured by the residual chlorine meter. The residual chlorine meter 50 is designed to compare a potential of first ORP 51-1 positioned in a return path Ch(3) with a potential of second ORP 51-2 positioned in the digest tank 30 for determining the residual chlorine concentration. The first ORP 51-1 system comprises a sampling device 52, a pump 55 for sending a filtered sample, a pair of magnetic valve 53 and 54 for washing the sampling device and ORP sensor 56 while the second ORP 51-2 system comprises a sampling device 52, a pump 55 for sending a filtered sample, a pair of magnetic valve 53 and 54 for washing the sampling device and ORP sensor 56. According to the signal of the residual chlorine concentration, the controller 100 can also control timing of washing the sampling device and adjustment of blower and so on as well as the concentration of acidulous sodium hypochlorite aqueous solution, the amount of sludge to be charged into the digest tank 30 and the mixing ratio of acidulous sodium hypochlorite aqueous solution.

The second example is a butch type system and can be designed easily into a run type system of the first example by the skilled in the art.

1. A method of digesting excess sludge produced in activated sludge system with hypochlorous acid which comprises;
taking the excess sludge from an activated sludge unit or a sludge sedimentation vessel and dumping the excess sludge into a sludge digesting unit
hypochlorous acid processing at least a part of the excess sludge in the sludge digesting unit by mixing the sludge with an acidulous hypochlorous acid aqueous solution at a mixture ratio of 500˜5,000 ppm based on excess sludge of about 5,000 to 10,000 mg/L after mixing,
returning to the activated sludge unit or. discharging out the processed sludge with a degree of substantially inert residual chlorine concentration.

2. A method of digesting excess sludge produced in activated sludge process according to claim 1, wherein said hypochlorous acid process is carried out by use of an acidulous sodium hypochlorite aqueous solution of 1,000̂′50,000 ppm which is acidificated to pH of more than 4 to less than 7 by hydrochloric acid.

3. A method of digesting excess sludge produced in activated sludge process according to claim 1, wherein the hypochlorous acid process is carried out by a plurality of digesting vessels connected with each other so as to make the excess sludge flow therethrough, wherein available chlorine concentration of the acidulous sodium hypochlorite aqueous solution to be mixed with the excess sludge flow in the upper-stream vessel is higher than that of the lower-stream vessel.

4. A method of digesting excess sludge produced in activated sludge process according to claim 1, wherein a return path from the sludge digesting unit to the activated sludge unit, is provided with a residual chlorine processing unit, wherein a residual chlorine concentration in the processed sludge is measured, and depending on the measured signal, a determined amount of the excess sludge is charged into the processed sludge in order to make the residual chlorine concentration substantially inert state.

5. A method of digesting excess sludge produced in activated sludge process according to claim 1, wherein at a return side of the activated sludge unit there is provided an auxiliary storage vessel, wherein some excess sludge is stocked to be mixed with the return processed sludge water and to make the processed sludge water substantially inert in the residual chlorine concentration.

6. A method of digesting excess sludge produced in activated sludge process according to claim 1, wherein the return path from the sludge digesting unit to the activated sludge there is provided with a measuring unit to measure the residual chlorine concentration in the processed sludge.

7. A method of digesting excess sludge produced in activated sludge process according to claim 2, wherein in response to the residual chlorine concentration measured by the measuring unit, a mixture ratio of the acidulous sodium hypochlorite aqueous solution to the sludge water in the sludge digesting unit, a charge amount of the sludge water to the residual chlorine processing unit, and/or a sludge concentration in the auxiliary storage vessel can be adjusted.

8. An equipment of digesting excess sludge produced in activated sludge system with a hydrochloric acid which comprises;
an activated sludge unit and a sludge sedimentation vessel,
a sludge digesting unit provided with means of mixing for processing at least a part of the excess sludge by an acidulous sodium hypochlorite aqueous solution,
a digest solution device for mixing a sodium hypochlorite aqueous solution with a hydrochloric acid aqueous solution to make the acidulous sodium hypochlorite aqueous solution of 1,000˜50,000 ppm and pH of more than 4 to less than 7,
a supplier for supplying the acidulous sodium hypochlorite aqueous solution of 1,000˜50,000 ppm to the excess sludge in the sludge digesting unit at a mixture ratio of 500˜5,000 ppm based on excess sludge of about 5,000 to 10,000 mg/L depending on the sludge concentration in the sludge digesting unit,
a first path for taking and supplying the excess sludge taken from the activated sludge unit or the sludge sedimentation vessel to the sludge digesting unit,
a second path for returning the processed sludge from the sludge digesting unit to the activated sludge unit,
a measuring device for detecting a residual chlorine concentration in the processed sludge,
an after-treating means for making the processed sludge substantially inert in response to the signal measured by the measuring device.

9. An equipment of digesting excess sludge produced in activated sludge process according to claim 8, wherein the sludge digesting unit comprises a plurality of mixing vessels connected each other in turn, each of which is provided with the supplier for the acidulous sodium hypochlorite aqueous solution wherein the concentration of acidulous sodium hypochlorite aqueous solution in the upper-stream vessel is higher than that of the lower-stream vessel.

10. An equipment of digesting excess sludge produced in activated sludge process according to claim 8, wherein the treating means for making the sludge substantially inert is a residual chlorine processing unit positioned in a return path from the sludge digesting unit to the activated sludge unit, wherein depending on a residual chlorine concentration in the processed sludge, a determined amount of the excess sludge is charged into the Processed sludge in order to make the residual chlorine concentration substantially inert state.

11. An equipment of digesting excess sludge produced in activated sludge process according to claim 8, wherein the means for making the processed sludge substantially inert is an auxiliary storage vessel provided at a return side of the activated sludge unit, wherein some excess sludge is stocked to make the processed sludge substantially inert in the residual chlorine concentration.

12. An equipment of digesting excess sludge produced in activated sludge process according to claim 8, further comprising a control unit for adjusting a mixture ratio of the hypochlorous acid to the sludge in the sludge digesting unit, a charge amount of the sludge to the residual chlorine processing unit, and/or a sludge concentration in the auxiliary storage vessel in response to the signal of residual chlorine concentration measured by the measuring unit.
